(19) United States
(12) Patent Application Publication
(10) Pub. No.: US 2003/0107325 A1
(43) Pub. Date: Jun. 12, 2003

(54) Removable photocell cover

(76) Inventor: James J. Birkhead, West Hills, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/316,632

(22) Filed: Dec. 10, 2002

Related U.S. Application Data
(60) Provisional application No. 60/339,550, filed on Dec. 10, 2001.

(51) Int. Cl. H05B 37/02

(52) U.S. Cl. 315/149

(57) ABSTRACT

A removable cover for a photocell housing having a photocell sensor for detecting light to activate lights or other electrical devices is disclosed. The cover is made of an opaque and resiliently flexible elastomeric material having an end wall and a skirt extending therefrom. An opening is formed at a distal edge of the skirt, such that the end wall and skirt define an internal cavity configured to removably receive the photocell housing therein. The cover conforms to the photocell housing to create a frictional-fit therewith so as to obstruct light from entering the photocell sensor to allow repair and maintenance of the lights or electrical devices controlled by the photocell sensor.

### RELATED APPLICATION

This application claims priority from U.S. Provisional Application Serial No. 60/339,550, filed Dec. 10, 2001.

### BACKGROUND OF THE INVENTION

The present invention generally relates to photoelectric cell sensors, and methods of obstructing the sensors to perform maintenance duties. More particularly, the present invention relates to a removable photocell cover which overcomes disadvantages of previous methods.

A photoelectric cell is an electronic device having an electrical output that varies in response to light. When a photocell senses a sufficient amount of light, the photocell turns off an electric circuit that the photocell is connected to. Similarly, when in the absence of light, the photocell turns on an electrical circuit that the photocell is connected to. Generally, a photocell is used to turn on a series of lights, such as outdoor lights, when the photocell senses that it is dark outside. When it is light again, the photocell turns those same lights off.

An individual, such as a grounds keeper, maintenance worker, or electrician, may need to turn on the lights during the day to replace burned out bulbs or make other repairs. This requires activating the photocell by covering the sensor thereof to simulate nighttime operation. Although placing one's finger or hand over the sensor can temporarily turn on the light, a cover is needed that obstructs the light from entering the sensor while all of the repairs and maintenance are performed on the various lights and circuits.

This is usually accomplished by covering the sensor with tape. However, some types of tape do not sufficiently obstruct the light, requiring multiple layers of tape. Other types of tape, such as electrician's or duct tape, are sufficiently opaque, but still require multiple layers in order to fully cover the sensor. As the photo sensors and housings are typically comprised of plastic and often placed on vertical walls or poles, the tape can dislodge or fall off from the sensor. Of course, this deactivates the photo sensor and switches the lights back off. Another problem with using tape on a photocell is that every time the tape is removed a residue is left behind on the sensor. Over time, this effects the reliability of the sensor as the tape residue increasingly obstructs the “vision” of the sensor. Also, when using tape to activate a photocell, it is very common to leave the mass of tape on the side of the photocell housing wall or box, causing an eyesore.

Accordingly, there is a need for a removable photocell cover that adequately blocks and obstructs the light from the photocell sensor, while overcoming the disadvantages described above. The present invention fulfills these needs and provides other related advantages.

### SUMMARY OF THE INVENTION

The present invention resides in a removable cover for a photocell housing having a photocell sensor for detecting light to activate lights or other electrical devices. The cover of the present invention is intended to overcome the disadvantages described above of covering photocell sensors for the benefit of electricians and maintenance workers. An added benefit of the present invention is that the cover is removable so as to be used repeatedly, and the cover is comprised of a material which enables it to be used on various sized and configured photocell housings.

The removable cover generally comprises an opaque and resiliently flexible material having an end wall and a skirt extending from the end wall and defining an opening at a distal edge thereof. The cover is comprised of an elastomeric foam material, preferably a neoprene material. The cover may have a generally square or jar-shaped configuration to correspond with the shape of the photocell housing, although due to the resiliently flexible material used therein, the cover is configured to be conformable to the photocell housing.

The end wall and skirt define an internal cavity which is configured to removably receive the photocell housing therein. As stated above, the cover is conformable to the photocell housing to create a frictional-fit therewith. Thus, with the cover placed over the photocell housing, light is obstructed from entering the photocell sensor such that lights or other electrical devices are activated for repair and maintenance purposes.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a photocell housing and assembly having a removable photocell cover of the present invention inserted thereon;

FIG. 2 is a partially exploded perspective view of the photocell sensor housing, with the cover exploded therefrom;

FIG. 3 is a cross-sectional view of the cover taken generally along line 3-3;

FIG. 4 is a perspective view of another photocell assembly having a removable photocell cover embodying the present invention inserted over a housing thereof;

FIG. 5 is a perspective view similar to FIG. 4, illustrating the removable cover the present invention removed from the photocell housing; and

FIG. 6 is a cross-sectional view taken generally along line 6-6 of FIG. 5.

### DETAILED DESCRIPTION OF THE PREFERRED EMBODIMENT

As shown in the attached figures for purposes of illustration, the present invention resides in a removable photocell cover 10 and 12 which is used to activate a photocell sensor 14 and turn on an electrical circuit powering lights or other electrical devices. Of course, the photocell sensor 14 may actually operate so as to turn off electrical devices when activated. The exact function of the photocell sensor 14 is not critical to the invention, rather the invention is concerned with the selective activation of the photocell sensor 14 by covering the photocell sensor 14 with the cover 10 or 12.

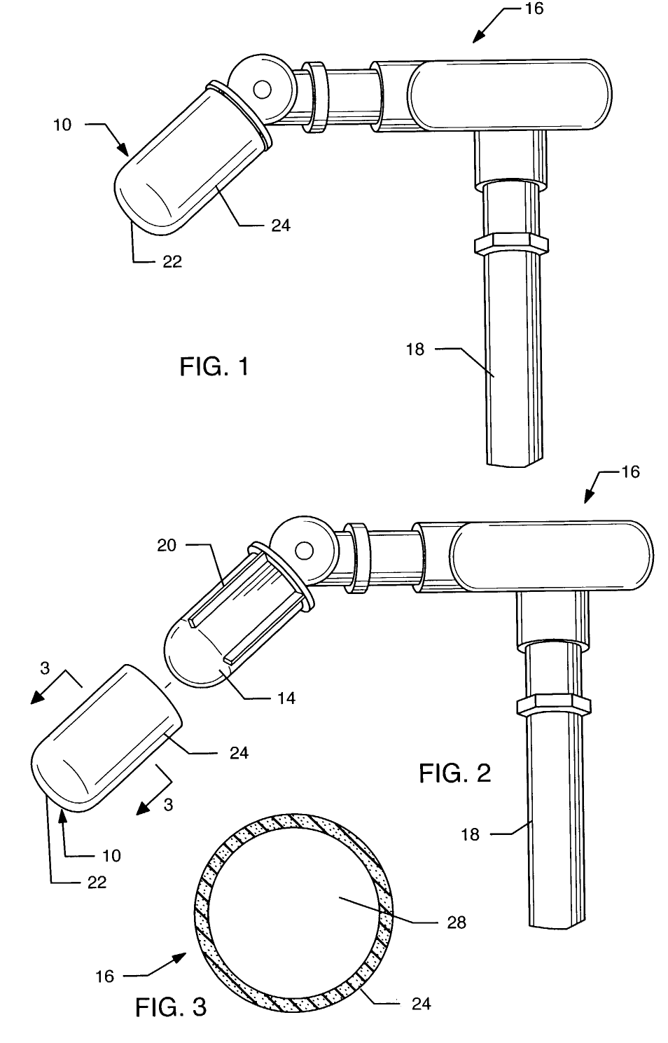

With reference now to FIGS. 1 and 2, a photocell sensor device 16 is illustrated which includes electrical conduit 18 or the like in order to relay the necessary electrical wires to a housing 20 in which the photocell sensor 14 resides. Such photocell sensor devices 16 are well-known in the art and are provided in a variety of sizes and shapes to meet the needs of the end user. In outdoor settings, such devices 16 are typically attached to a beam support of a roof or the like so as to be exposed to the natural sunlight. The photocell sensor housing 20 is generally transparent to the light such that the light can activate or deactivate the photocell sensor 14 therein.

With reference now to FIGS. 1-3, the present invention resides in a cover 10 which is comprised of a resilient material that can be frictionally fitted over the photocell sensor housing 20 and which completely obstructs light from entering into the sensor 14. The cover 10 is comprised of an end wall 22 having a skirt 24 extending downwardly therefrom. As illustrated, the skirt 24 is generally cylindrical. At an end of the cover 10 generally opposite the end wall 22 is an opening 26 configured to receive the housing 20 of the photocell device 16.

The cover 10 is comprised of a material which is opaque or rather thick in order to obstruct light adequately. The material is preferably elastomeric in nature so as to conform to the sensor 14 and housing 20. Open or closed cell foam materials, such as neoprene or the like, is preferred as this material is conformable to the various shaped photocell sensor housings 20, obstructs light from entering into the sensor 14, is easy to store and carry, and is not easily damaged and resistant to wet weather conditions.

As illustrated in FIGS. 1-3, the cover 10 is generally jar-shaped and sized so as to fit over the housing 20 of the photocell sensor device 16. Preferably, the open end 26 of the cover 10 should be of such a size so that it is slightly less in diameter than the outer diameter of the photocell sensor housing 20. In this manner, when the cover 10 is force-fitted over the housing 20, it must conform to the shape of the housing 20 and form a frictional fit. Thus, even when the photocell sensor housing 20 is directed downwardly, as illustrated, the cover 10 will not fall off and must be manually removed from the photocell sensor housing.

The cover 10 or 12 of the present invention is typically constructed by cutting a strip of neoprene or other elastomeric material to a sufficient width and length so as to surround the photocell sensor housing 20. The ends of the strip are attached to one another, such as by adhesives or stitching. A generally square cylindrical body is thus formed. Alternatively, multiple strips of the material may be attached to one another to form a multi-faceted skirt. A cap of neoprene or elastomeric material is then attached, such as by adhesive or stitching, to an open end of the skirt 24 to create the end wall 22 and complete the open-ended cover 10 or 12. The open end 26 and a central cavity 28 of the cover 10 or 12 should be of such a size so that it is slightly less in diameter than the outer diameter of the photocell sensor housing 20.

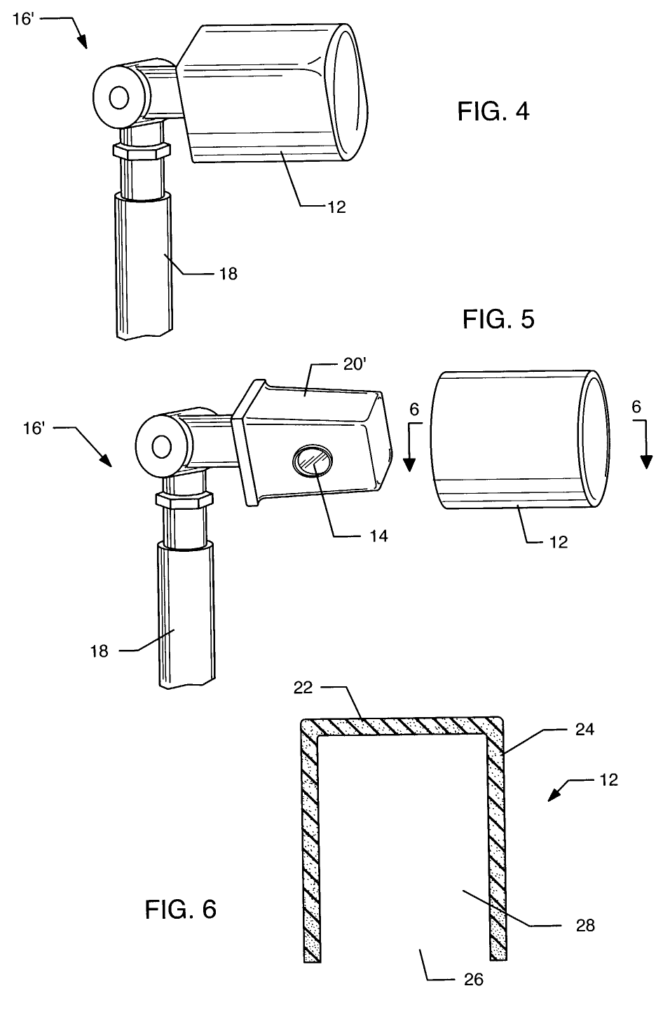

With reference to FIGS. 4-6, another photocell sensor device 16′ is illustrated having a generally square photocell housing 20′. The photocell sensor, or a window therefor, can be seen embedded within the housing 20′. A cover 12, constructed as described above, forms a frictional fit with the housing 20′ so as to conform thereto, as illustrated in FIG. 4. Although the cover 12 can be constructed so as to be of a generally square shape to correspond with the shape of the photocell sensor housing 20′, due to the selection of the resiliently flexible material, such is not necessary as the generally cylindrical and jar-shaped cover 12 illustrated will conform to the square housing 20′, as illustrated in FIG. 4. Due to the conforming nature of the cover 10 or 12, a single cover 10 or 12 can be used on various sized and configured photocell sensor housings 20 and 20′. Thus, the electrician or maintenance worker need only purchase a single cover for use on various photocell sensors and housings.

In use, the electrician or maintenance worker places the cover 10 or 12 over the photocell sensor housing 20 and then makes whatever repairs are necessary in that particular electrical circuit. When finished with such maintenance repair, the electrician or maintenance worker simply removes the cover 10 or 12 by prying the cover from the housing 20, in a manner similar to a glove or the like. The cover 10 or 12 of the present invention can then be reused at a later time, or on different photocell sensors 14 and other electrical circuits.

The advantages of the present invention will be readily appreciated by those skilled in the art. The electrician or maintenance worker need not fear that the cover will accidentally dislodge or fall from the photocell sensor. Also, upon removing the cover 10 or 12 from the photocell sensor housing 20, there is no residue remaining on the sensor, thus maintaining the photocell sensor in an optimal operating state. Moreover, the present invention eliminates the unsightly masses of tape left on the sides of photocell sensor housings, as has been done in the past.

Although several embodiments have been described in detail for purposes of illustration, various modifications may be made without departing from the scope and spirit of the invention. Accordingly, the invention is not to be limited, except as by the appended claims.

What is claimed is:

1. A removable cover for a photocell housing having a photocell sensor for detecting light to activate lights or other electrical devices, the cover comprising:
a cover comprised of an opaque and resiliently flexible material having an end wall and a skirt extending from the end wall and defining an opening at a distal edge thereof, the end wall and skirt defining an internal cavity configured to removably receive the photocell housing therein so as to obstruct light from entering the photocell sensor.

2. The photocell sensor cover of claim 1, wherein the cover is comprised of an elastomeric foam material.

3. The photocell sensor cover of claim 2, wherein the cover is comprised of a neoprene material.

4. The photocell sensor cover of claim 1, wherein the cover is configured to be conformable to the photocell housing to create a frictional-fit thereon.

5. The photocell sensor cover of claim 1, wherein the cover has a generally square configuration.

6. The photocell sensor cover of claim 1, wherein the cover has a generally jar-shaped configuration.

7. A removable cover for a photocell housing having a photocell sensor for detecting light to activate lights or other electrical devices, the cover comprising:
a cover comprised of an opaque and resiliently flexible elastomeric foam material having an end wall and a skirt extending from the end wall and defining an opening at a distal edge thereof, the end wall and skirt defining an internal cavity configured to removably receive the photocell housing therein, whereby the cover conforms to the photocell housing to create a frictional-fit therewith so as to obstruct light from entering the photocell sensor.

8. The photocell sensor cover of claim 7, wherein the cover is comprised of a neoprene material.

9. The photocell sensor cover of claim 7, wherein the cover has a generally square configuration.

10. The photocell sensor cover of claim 7, wherein the cover has a generally jar-shaped configuration.

11. A combination photocell housing and removable cover, comprising:
a photocell housing having a photocell sensor for detecting light to activate lights or other electrical devices; and
a cover comprised of an opaque and resiliently flexible elastomeric foam material having an end wall and a skirt extending from the end wall and defining an opening at a distal edge thereof, the end wall and skirt defining an internal cavity configured to removably receive the photocell housing therein, whereby the cover conforms to the photocell housing to create a frictional-fit therewith so as to obstruct light from entering the photocell sensor.

12. The photocell sensor cover of claim 11, wherein the cover is comprised of a neoprene material.

13. The photocell sensor cover of claim 11, wherein the cover and the housing have a generally square configuration.

14. The photocell sensor cover of claim 11, wherein the cover and the housing have a generally jar-shaped configuration.
